(19) United States
(12) Patent Application Publication
(10) Pub. No.: US 2011/0311945 A1
(43) Pub. Date: Dec. 22, 2011

(54) RING FOR USE IN PREPARING TEETH FOR RESTORATION

(75) Inventors: Raymond L. Bertolotti, Oakland, CA (US); Mark S. Fernwood, Danville, CA (US)

(73) Assignee: Danville Materials,Inc.

(21) Appl. No.: 12/527,401

(22) PCT Filed: Feb. 15, 2008
(86) PCT No.: PCT/US08/54112

§ 371 Date: Mar. 7, 2011

Related U.S. Application Data
(60) Provisional application No. 60/890,239, filed on Feb. 16, 2007.

(51) Int. Cl. A61C 3/00; B23P 17/04; A61C 5/12

(52) U.S. Cl. 433/139; 433/148; 433/215; 29/428

(57) ABSTRACT

The invention is an open-ended dental ring with varying height used in the preparation of a tooth for a restorative procedure. The ring is used in conjunction with a shield to ensure the shield between a tooth to be restored and an adjacent tooth. The result is a close contact being formed between the two teeth after restoration and improved flexibility recall after repeated use.

### CROSS-REFERENCE TO RELATED APPLICATIONS

This application claims the benefit under 35 U.S.C. § 119(e) of United States Provisional Patent Application No. 60/890,239 filed on Feb. 16, 2007, which is hereby incorporated by reference in its entirety.

### BACKGROUND OF THE INVENTION

1. Field of Invention

This invention relates to an apparatus and method for preparing one or more teeth for restoration. The invention is useful for dental applications. The invention also relates to a method of preparing the apparatus.

2. Prior Art

Today, increasing numbers of patients are requesting posterior composites for aesthetic and health concerns. During the procedure, a tight contact between teeth is desirable to avoid grinding and further damage to the teeth and drifting of teeth. Customarily, the means for preparing a tooth for restoration with a restorative material has been the following: a contact shield and a ring with two tines placed between two teeth, one of which is a select tooth for restoration. The tines of the ring press the select tooth away from its adjacent tooth and press the shield against the select tooth. The select tooth is then ready for a number of restorative processes. Several different types of rings exist in the art, though these rings have several problems. First, the rings are not very retentive when placed between two teeth. Second, opening of the rings are limited that they are not suitable for use when wide preparations are required. Most importantly, the rings tend to deform, i.e. they do not swing back to their original shapes after opening and use on a tooth due to stress. To avoid deformation, one solution offered by the prior art is a two ring system having a inner ring and an outer ring. (US Patent Application 2005/0147941). The inner ring has two tines and can be used to press the select tooth away from its adjacent tooth and press the shield against the select tooth. However, this ring tends to deform when used. Therefore an outer ring is employed to keep the first ring in shape. The outer ring is made from materials having high elastic yield points, such as stainless steel or Ni—Ti alloy. Thus, the outer ring can keep the inner ring in shape. However, the materials, especially the Ni—Ti alloy which is used in a commercial embodiment of the subject matter of US Patent Application 2005/0147941, is expensive and hard to fabricate. Therefore it is only made into a ring without the tines and only used as an outer ring to keep the inner ring in shape, and is not used as a useable dental ring itself. Therefore, this two ring system is quite expensive, and inconvenient to use due to the fact that the two rings have to be placed together. Thus, there is a need for dental rings that can resist deformation after repeated use and are more convenient and less costly.

The apparatus of the invention provides a more retentive ring, with better separating force, and less likely to deform after repeated use. Further, it can be used in a normal or inverted orientation, used in normal or wide preparations, as well as being able to be stacked upon one another.

### SUMMARY OF THE INVENTION

One aspect of this invention is a flexible, open-ended dental ring having top and bottom surfaces that define a varying height of the ring, wherein the height of the ring is (a) at its maximum at about the middle of the closed portion of the ring, and (b) at its minimum near the open ends of the ring, with the maximum height of the ring being sufficient to prevent the ring from permanently deforming when the open ends are spread for placement on a tooth.

Another aspect of the invention is a flexible open-ended dental ring having top and bottom surfaces that define a varying height of the ring, the ring having two downwardly extending tines that are incorporated into the open ends of the ring about opposite from the opposing closed portion of the ring, wherein the height of the ring is (a) at its maximum about at the middle of the closed portion of the ring, and (b) at its minimum near the portion of the ring where the tines extend downward, with the maximum height of the ring being sufficient to prevent the ring from permanently deforming when the tines are opened for placement on a tooth.

Another aspect of this invention is a method of preparing a tooth for restoration. The method comprises:
(a) placing a shield between two or more teeth, one tooth being a select tooth for restoration;
(b) inserting between the select tooth and a tooth adjacent to the select tooth, a flexible open-ended dental ring having top and bottom surfaces that define a varying height of the ring, the ring having two downwardly extending tines that are incorporated into the open ends of the ring about opposite from the opposing closed portion of the ring, wherein the height of the ring is at its maximum about at the middle of the closed portion of the ring, and at its minimum near the portion of the ring where the tines extend downward, with the maximum height of the ring being sufficient to prevent the ring from permanently deforming when the tines are opened for placement on a tooth; and
(c) causing the tines of the ring to gently press the select tooth away from the adjacent tooth, and to secure the shield against the select tooth.

Another aspect of the invention is a kit for preparing teeth for restoration, comprising:
(a) one or more flexible open-ended dental rings having top and bottom surfaces that define a varying height of the ring, wherein the height of the ring is at its maximum at about the middle of the closed portion of the ring, and at its minimum near the open portion of the ring, with the maximum height of the ring being sufficient to prevent the ring from permanently deforming when the open ends are spread for placement on a tooth; and
(b) one or more shields designed for use with the open-ended rings.

Another aspect of the invention is a kit for preparing teeth for restoration, comprising:
(a) one or more flexible open-ended dental rings having top and bottom surfaces that define a varying height of the ring, the ring having two downwardly extending tines that are incorporated into the open ends of the ring about opposite from the opposing closed portion of the ring, wherein the height of the ring is at its maximum about at the middle of the closed portion of the ring, and at its minimum near the portion of the ring where the tines extend downward, with the maximum height of the ring being sufficient to prevent the ring from permanently deforming when the tines are opened for placement on a tooth; and
(b) one or more shields designed for use with the open-ended rings.

Another aspect of the invention is a method for preparing a flexible, open-ended dental rings, which method comprises forming a flexible, open-ended dental ring having top and bottom surfaces that define a varying height of the ring, wherein the height of the ring is (a) at its maximum about at the middle of the closed portion of the ring, and (b) at its minimum near the open ends of the ring, with the maximum height of the ring being sufficient to prevent the ring from permanently deforming when the open ends are opened for placement on a tooth.

Another aspect of the invention is a method for preparing a flexible, open-ended dental rings, which method comprises forming a flexible, open-ended ring having top and bottom surfaces that define a varying height of the ring, the ring having two downwardly extending tines that are incorporated into the open ends of the ring about opposite from the opposing closed portion of the ring, wherein the height of the ring is (a) at its maximum at about the middle of the closed portion of the ring, and (b) at its minimum near the portion of the ring where the tines extend downward, with the maximum height of the ring being sufficient to prevent the ring from permanently deforming when the tines are opened for placement on a tooth.

### BRIEF DESCRIPTION OF THE DRAWINGS

The invention is best understood from the following detailed description when read in conjunction with the accompanying drawings. It is to be understood that, according to common practice, the various features of the drawings may not be to-scale.

FIG. 1 is a perspective view of an open-ended ring with varying height and with two downwardly extending tines.

FIGS. 2A-2C are each a front view of a flattened ring with varying height and with two downwardly extending tines.

FIG. 3A is a front view of a ring with varying height and with the first tine inward edge converging towards second tine inward edge.

FIG. 3B is a front view of a ring with varying height and with the first tine inward edge diverging away from second tine inward edge.

FIG. 4A is a top view of the ring of FIG. 3B.

FIG. 4B is a top view of the ring of FIG. 3A.

FIG. 5 is a front view of a prior art ring with uniform height.

FIG. 6 is a perspective view of a shield and a ring positioned between two teeth.

FIG. 7 is a top view of a shield and a wedge positioned between two teeth.

FIG. 8 is a perspective view of two shields and two rings being used concurrently.

FIG. 9A is a side view of the ring with varying height and with each of the tines at a right angle from the plane of the ring.

FIG. 9B is a side view of the ring with varying height and with each of the tines at an obtuse angle from the plane of the ring.

FIGS. 10-17 are various reviews of a ring of Example 1.

FIGS. 18-25 are various reviews of a ring of Example 2.

FIG. 26 is a side view of part of a ring showing tine with a “V” shaped notch and varying height.

FIG. 27 is a perspective view of a ring with varying height and with each of the tines folded in a ridge shape.

FIG. 28 is a perspective view of a ring of FIG. 27 positioned between two teeth.

FIG. 29 is a top view of a ring of FIG. 27 positioned between two teeth.

FIG. 30 is a top view of a flattened ring with varying thickness.

FIG. 31 is a side view of a tine with straight inner and outer faces.

FIG. 32 is a side view of a tine with a curved inner face and a curved outer face.

FIG. 33 is a front view of a tine with a curved bottom edge that comes to a point.

### DETAILED DESCRIPTION OF THE PREFERRED EMBODIMENTS

Definitions

Restoration of a tooth is a method for returning the tooth to its normal morphology or close to its normal morphology and anatomy through the use of restorative materials.

The types of restorative processes performed with the disclosed device are known in dentistry as class II type restorations. Class II restorations of the type where the disclosed device is particularly useful involve the occlusal tooth surface and either the mesial or distal interproximal region of the tooth. The area where two adjacent teeth touch is referred to as the interproximal region. When the mesial or distal interproximal section of a tooth needs to be removed due to a carious lesion, the disclosed device and method allows the tooth anatomy to be restored in an optimal way replacing in an acceptable manner the original interproximal tooth contact.

Restorative materials are those materials commonly used by one skilled in the art of dentistry to restore a damaged tooth and include, but are not limited to, composites, silver, gold, porcelain, almagams, alloys, wax, temporaries, and other known restorative materials.

The plane of the ring is defined as the plane that is perpendicular to the column formed by the inner surface of the ring.

An acute angle is an angle less than 90 degrees.

An obtuse angle is an angle between 90 and 180 degrees.

A right angle is an angle of 90 degrees.

A shield is a protective device or structure that can be placed between two teeth to aid in the tooth restoration process.

A tooth can belong to a human or non-human animal, and can be contained within the animal or outside of the animal. A tooth can be a cast or replica of a tooth obtained from or similar to a human or non-human animal. A tooth can be an incomplete or a complete tooth.

“Occlusal offset” refers to the angulation of the plane of the ring relative to the occlusal plane of a tooth, i.e. the grinding or biting surface of a tooth.

The “upper flat table” of a tooth is the flat portion of the tooth that contacts an opposite tooth when the top and bottom jaws come together.

“Toggling of the tooth” means the lateral movement of a tooth.

“Permanent deformation of a dental ring” or “permanently deforming a dental ring” means that after being expanded, the ring cannot return to its original shape and its shape deviates from its original shape to an extend that the ring is clinically unusable for its intended use in a dental restoration process and/or cannot be reused.

“Flexibility recall” means the ability of a dental ring to return to its original shape or approximately its original shape after being expanded by a dentist for its intended use in a tooth restoration process. This allows a dental ring to be used multiple times with intermittent sterilization.

In describing the details of the invention, the term “about” when used with a numerical value to indicate, for example a dimension, is intended to indicate that such a numerical value may vary within a reasonable range, such as ±10%, preferably ±5%, and more preferably ±1%, for example due to manufacture deviations.

Terms not defined herein have a meaning as would be understood by one skilled in the art looking to standard dictionaries used in the art of dentistry. Measurements presented in English units can be converted to metric units using standard conversion factors known in the art.

The Ring

A broad aspect of this invention is a flexible, open-ended dental ring having top and bottom surfaces that define a varying height of the ring, wherein the height of the ring is (a) at its maximum at about the middle of the closed portion of the ring, and (b) at its minimum near the open portion of the ring, with the maximum height of the ring being sufficient to prevent the ring from permanently deforming when the open ends are spread for placement on a tooth.

The ring of the invention is flexible enough to expand to fit around a tooth being prepared for restoration and has an internal tension sufficient to hold a shield in place near the tooth as discussed hereinafter. The ring of this invention is designed to have increased stiffness over dental rings known in the art to result in improved flexibility recall of the ring. This improved flexibility recall allows the dental ring of this invention to be used multiple times without permanently deforming. The ring can be used on different patients with autoclaving or other sterilization techniques occurring between uses on different patients. A dentist can easily open the ring using a pair of standard, hand-operated ring pliers in a regular clinical environment. For example, the contact ring pliers available from Danville Materials, Inc. (San Ramon, Calif., U.S.A) can be used for forcing the ring open for placement on a dental patient's tooth that is being restored.

In one embodiment of this invention, the increased stiffness and flexibility recall is obtained by varying the height of the middle portion of the open-ended dental ring relative to the height of the ring near the open portion of the dental ring. The height of the ring is defined by the top or upper surface 5 and the bottom surface 6, as shown in FIG. 1. By varying the height and thus increasing the stiffness, the likelihood of permanent deformation is significantly reduced, so that the ring is openable but does not permanently deform to a clinically significant amount as it opens and closes multiple times.

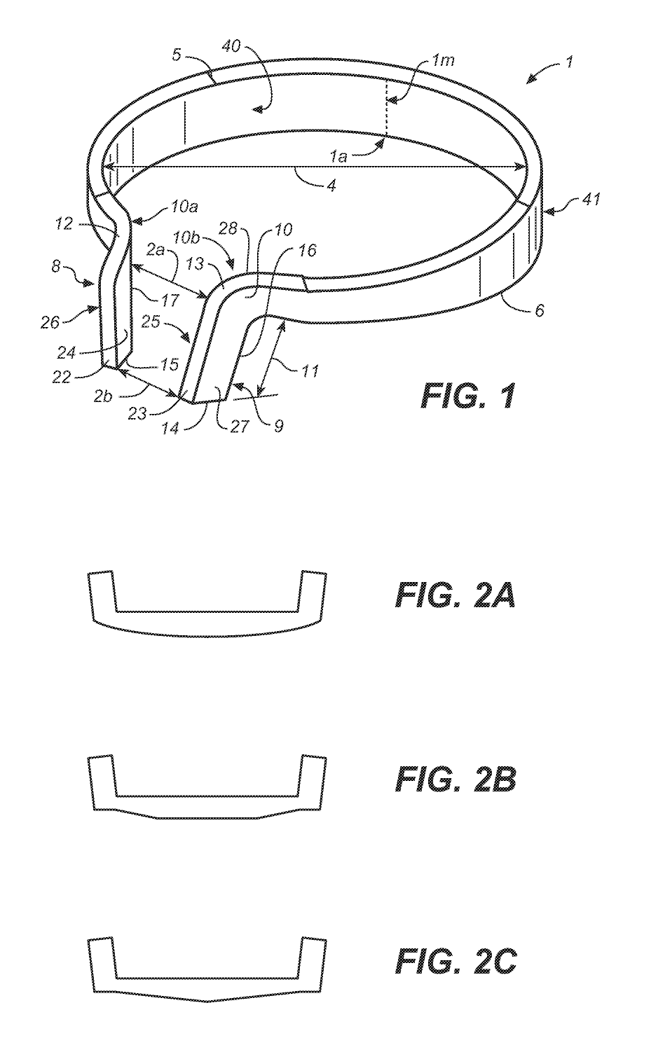

FIG. 1 shows one embodiment of the flexible, open-ended ring with varying height. As shown in FIG. 1, the open-ended ring 1 has a closed portion la, a first open end 10a and a second open end 10b. The mid-point lm of the closed portion of the ring can be viewed as the portion that is equidistance from the two open ends 10a and 10b of the ring. Generally, the height of the ring is at its minimum at the portions close to the open ends 10a and 10b of the ring and increases to its maximum at the portions close to the mid-point 1m. The increase in height can be a gradually continuous increase. Alternatively, the increase in height can be achieved by one or more steps, with or without a slope merging two adjacent steps. Still alternatively, the increase in height can be achieved by one or more straight angles leading to the middle of the closed portion. Other configurations to achieve the height increase will be obvious to a person skilled in the art. These and other alternatives will be referred to collectively as “curve” or “curved” in the specification and claims of the application. Either the top surface or the bottom surface may be curved to realize the height increase, and thus, leaving the opposite surface planar and parallel to the plane of the ring. Alternatively, both of the upper surface and the bottom surface may be curved to realize the height increase. FIG. 2A shows a front view of a flattened ring wherein the increased height is achieved by a gradual radius or parabolic curve of the top surface and wherein the bottom surface remains flat. FIG. 2B shows a front view of a flattened ring wherein the increased height is achieved by one step and wherein the bottom surface remains flat. FIG. 2C shows a front view of a flattened ring wherein the increased height is achieved by a straight angle leading to the middle of the top surface and wherein the bottom surface remains flat.

In one preferred embodiment, the portion of the dental ring that has increased height is the portion that is about 90 degrees on either side of the mid-point 1m, as shown in FIG. 4A from 1m to point B on both sides. Thus, about 180 degrees of this embodiment of the ring may generally be increased in height. At this portion of the ring, either the top surface or the bottom surface or both the top surface and the bottom surface may be curved to realize the height increase. The height of the remaining portions which are close to the open ends is constant. Therefore the top surface and bottom surface of these portions are planar and are parallel to the plane of the ring.

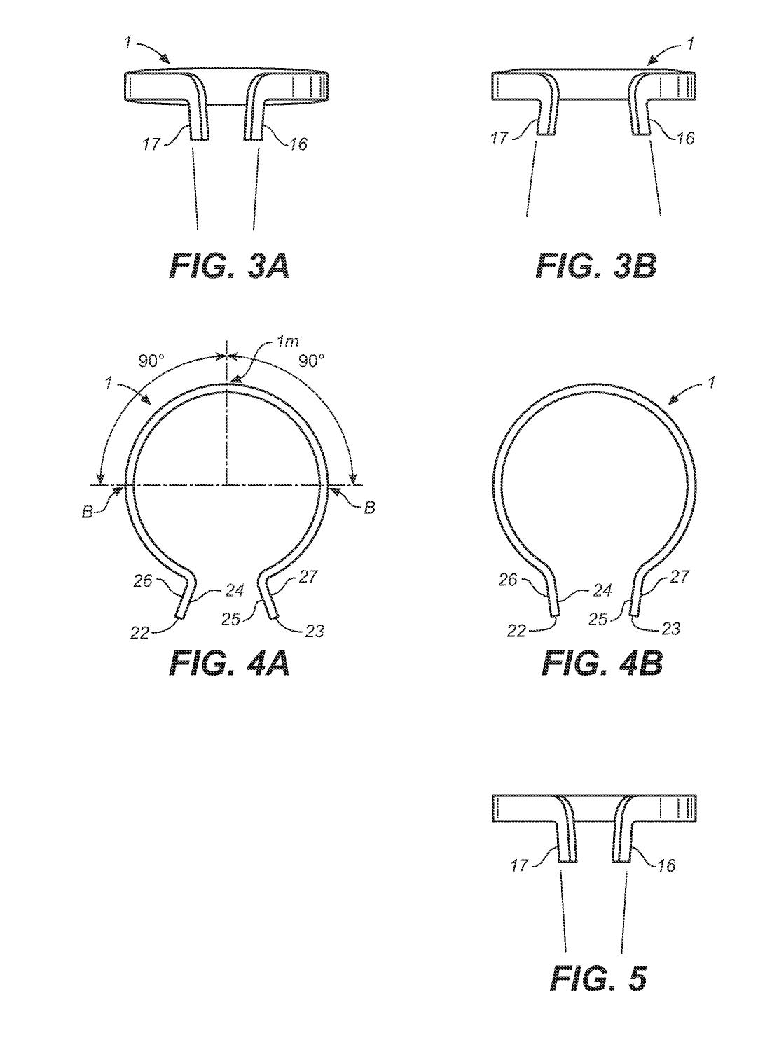

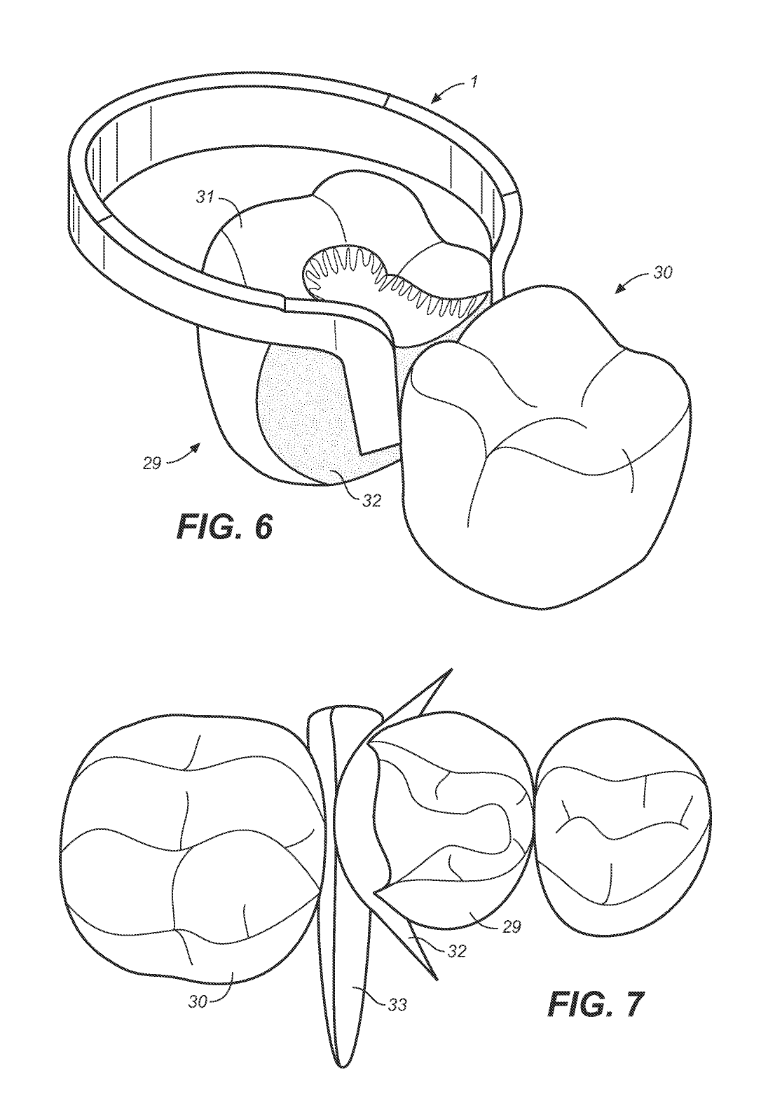

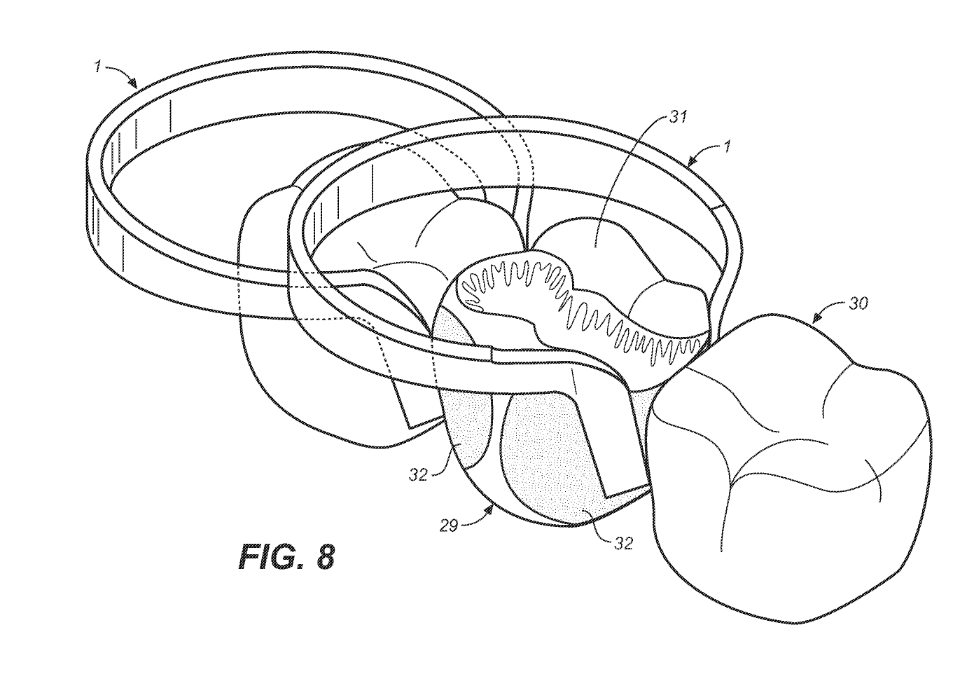

Generally, the maximum height of a ring is about 110% to about 200% of the minimum height of the ring, preferably from about 120% to 130%, and more preferably about 125%. For example, in a ring that has a minimum height of 0.12 inches (“in”), the maximum height may be from about 0.132 in to about 0.24 in. The varying height is better shown in FIGS. 3A and 3B, front views of two embodiments of ring 1, and FIGS. 9A and 9B, side views of two embodiments of ring 1. FIG. 5 shows a front view of a prior art ring wherein the height of the ring is uniform.

An alternative to increasing height to achieve flexibility recall is to keep the height constant and increase the thickness of the ring to achieve a stiffer ring. FIG. 30 shows a top view of a flattened ring have a varying thickness.

The shape of the ring includes, but is not limited to, circular, oval, triangular, rectangular, square or oblong. Preferably it is circular as shown in FIG. 1. The diameter of the “hoop” of the ring will be of a size that will allow a dentist to use the ring for restoration purposes in accordance with standard practice. Generally the inner diameter of the ring is from about 0.20 in to 1.20 in, preferably, this diameter is from about 0.70 in to about 0.90 in, more preferably about 0.80 in.

In FIG. 1, the inner surface of the ring 40 and outer surface of the ring 41 define the thickness of the ring. Generally, the thickness of the ring is uniform around the entire ring although it is contemplated that the thickness can be varied as shown in FIG. 30. The thickness is from about 0.030 in to about 0.20 in. Preferably the thickness of the ring may range between about 0.035 in to about 0.050 in, but generally is about 0.042 in.

Accordingly, in one embodiment, the thickness of the ring is uniform. In another embodiment, thickness in not uniform.

In one embodiment, the maximum height is from about 110% to 200% of the minimum height.

In one embodiment, the maximum height of the ring is about 125% of the minimum height of the ring.

In one embodiment, the thickness of the ring is from about 0.035 in to 0.20 in, the height of the ring at its maximum is from about 0.12 in to 0.18 in, the height of the ring at its minimum is from about 0.10 in to 0.14 in.

In one embodiment, wherein the inner diameter of the ring is from about 0.6 in to 1.0 in, and the open ends can be spread up to about 12 millimeters without permanent deforming.

In one embodiment, the inner diameter of the ring is about 0.8 in, and the open ends can be spread up to about 12 millimeters without permanent deforming.

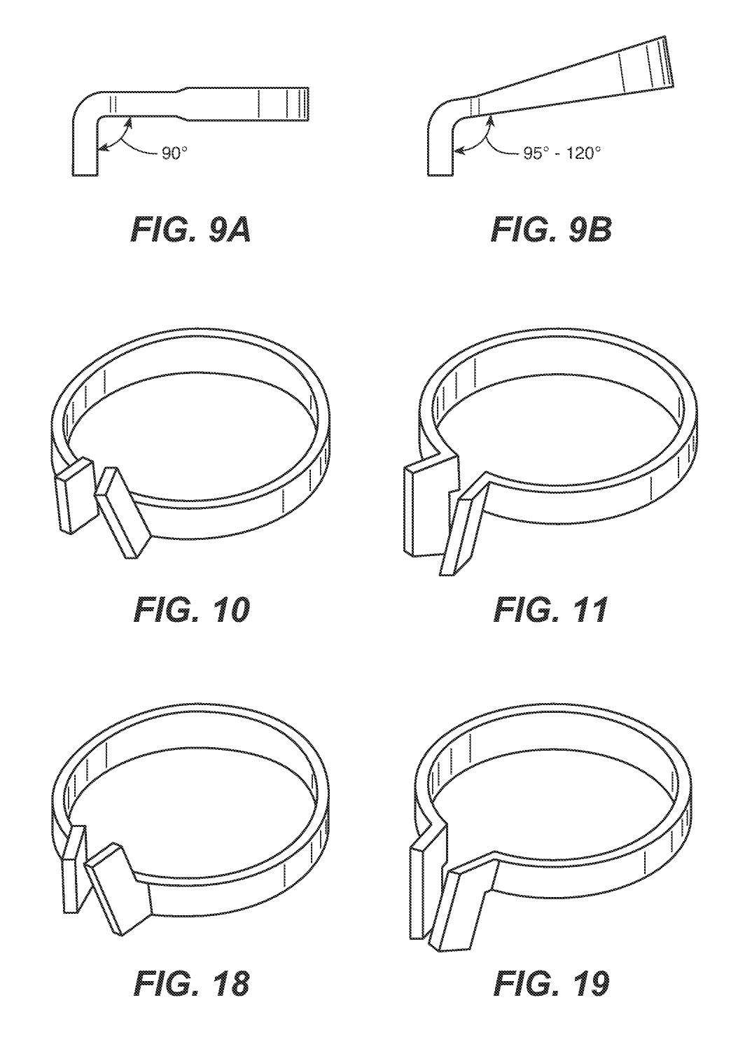

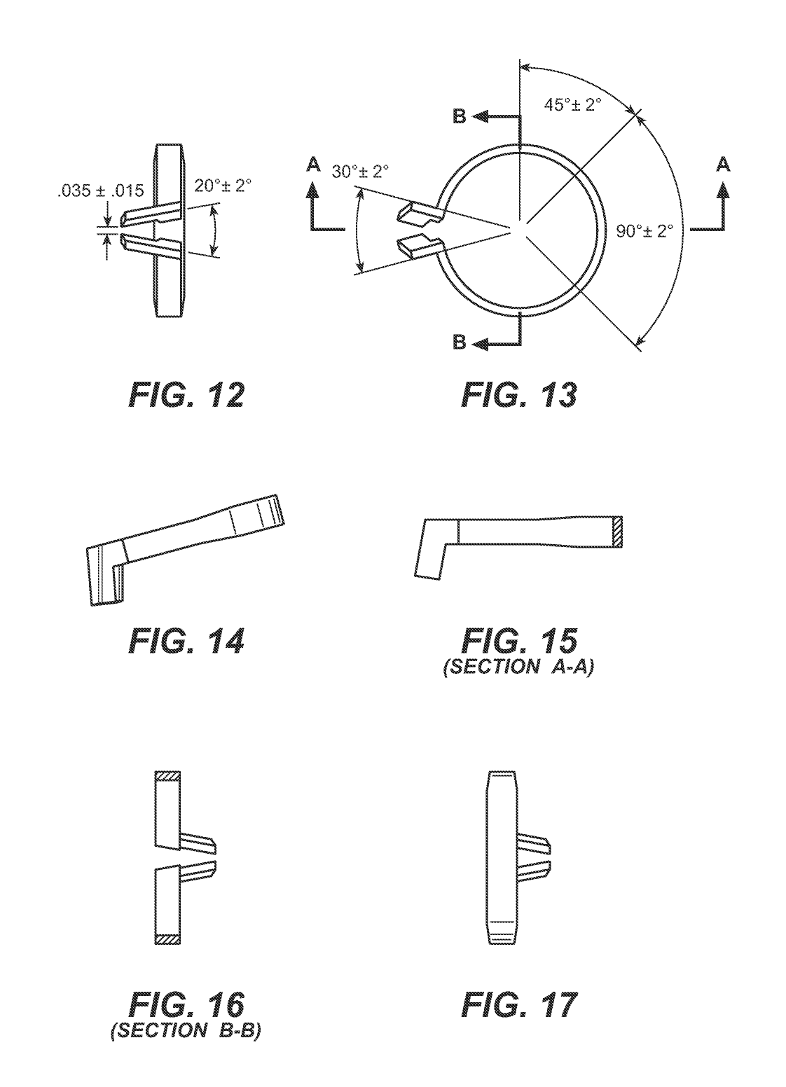

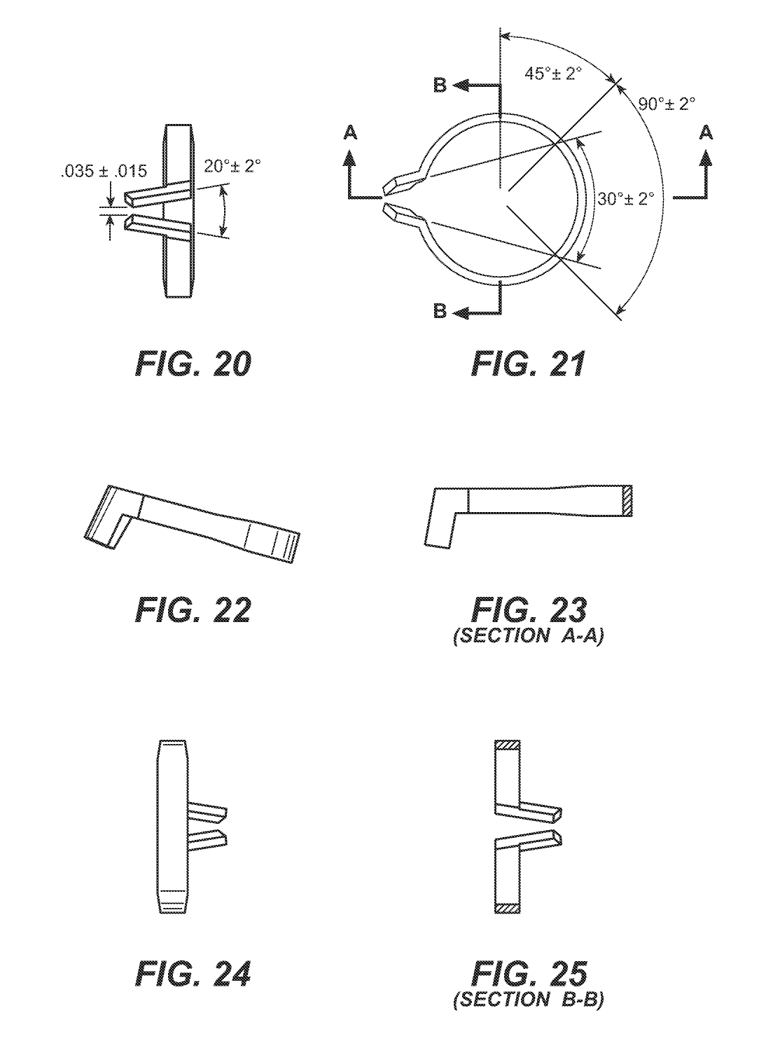

A usual configuration of the ring has two downwardly extending tines 8 and 9, as shown in FIG. 1. In its unexpanded condition of one embodiment, the tips of tines 8 and 9 may in essence touch each other. But from an ease of manufacturing stand point, the tines 8 and 9 are separated by a small gap, e.g., from about 0.020 in to about 0.050 in, typically about 0.035 in, as shown in FIGS. 12 and 20. Preferably, in a ring having an inside diameter of about 0.80 in, a dentist using a standard ring pliers with a 2:1 ratio leverage benefit, may spread the tines apart up to about 12 mm (0.47 in) without any clinically significant permanent deformation of the ring.

The ring is preferably an autoclavable material selected from the group consisting of alloy, chrome, stainless steel, rubber and plastic. Autoclaving allows for sterilization of the ring. Alternatively, the ring can be sterilized by treatment with alcohol or other disinfectants. While the materials useful for making the ring of this invention are known to one of skill in the art, those materials described in U.S. Pat. Nos. 5,681,528 and 5,855,844 are particularly useful, both of which are incorporated herein by reference. Precipitation hardenable stainless steel such as Carpenter Technology Corp's Custom 465®, 450, 455, 17-4, or 17-7 stainless steel heat treated to RH 950 are found to be satisfactory for making the ring of the invention, although other suitable materials may be used as well.

Generally, the flexible, open-ended dental ring has two downwardly extending tines permanently incorporated into the open ends of the ring. In other embodiments, the two tines can be detached from the ring and attached to the ring when needed via a connection mechanism. Such connection mechanism can be in the form a protruding finger on the tine and a complementary cavity on the ring close to each of the open ends 10a and 10b to receive the protruding fingers of the tines to be attached. Likewise, the connection mechanism can be in the form a cavity on the tine and a corresponding protruding finger on the ring close to each of the open ends 10a and 10b to be inserted into the cavity of the tines to be attached. In one embodiment, the tines can be secured to the ring by twisting the protruding finger relative to the cavity thereby locking the protruding part inside the cavity. The tines can be detached from the ring by twisting the protruding finger in the opposite direction and unlock the protruding part from the cavity. In another embodiment, the tines and cavities can contain complementary threads on their surfaces so that the tines can be secured to the ring by screwing the protruding finger into the cavity. In yet another embodiment, the tines can be secured by a latch or other types of fasteners. Other connection means should be obvious to a person skilled in the art. The tines may be made from a material that is the same as or different from the material of the ring. The tines can be reused or can be disposable.

Both first 8 and second 9 downwardly extending tines contain smooth edges and faces. Each tine can be at an acute, an obtuse angle or a right angle, preferably from about 80 degree to 120 degrees from plane of the ring. FIG. 9A shows a side view of a ring having tines at a right angle from the plane of the ring. FIG. 9B shows a side view of a ring having tines at an obtuse angle from the plane of the ring. As shown in FIG. 1, first tine 8 has a top edge 12, a bottom edge 15, an inward edge 17, an outward edge 22, an inner face 24, and an outer face 26 (not visible in FIG. 1). The inner face 24 and outer face 26 of first tine 8 are shown in FIGS. 4A and 4B as a top view. Second tine 9 has a top edge 28, bottom edge 14, an inward edge 16, an outward edge 23, an inner face 25 (not visible in FIG. 1), and an outer face 27. The inner face 25 and outer face 27 of the second tine 9 are shown in FIGS. 4A and 4B as a top view. In one embodiment, the top edge 12 of the first tine 8 curves downward towards the bottom edge 15 of the tine and the top edge 28 of the second tine 9 curves downward 13 towards the bottom edge 14 of the tine.

Generally, both first 8 and second 9 downwardly extending tines may have identical dimensions. The length 11 of the tine 9 is measured from the bottom surface of the ring 6 to the bottom edge of the tine 14, and is between 0.078 in to 0.31 in, preferably about 0.20 in. The width of the tine 9 is measured from the outward edge 23 to inward edge 16, and is between 0.078 in to 0.31 in, preferably about 0.13 in.

In one embodiment, the distance from the top edge to the bottom edge of each tine is from about 0.16 in to about 0.22 in.

In one embodiment, the width of each of the tines as defined by the distance between the inward edge and the outward edge is from about 0.10 in to about 0.20 in. In one embodiment, the width of each of the tines is from about 0.10 in to about 0.15 in. In one embodiment, the width is about 0.13 in.

In some embodiments of the flexible, open-ended dental ring 1, the inward edge 16 of second tine 9 may be parallel to the inward edge 17 of first tine 8. In a preferred embodiment of the flexible, open-ended dental ring 1 the inward edge 16 of second tine 9 converges towards the inward edge 17 of first tine 8, as shown in FIG. 3A as a front view and FIG. 4B as a top view. In another preferred embodiment of the flexible, open-ended dental ring 1 the inward edge 16 of second tine 9 diverges away from the inward edge 17 of first tine 8, as shown in FIG. 3B as a front view and FIG. 4A as a top view.

The converging or diverging orientations of the inward edges of the tines allow the ring to be used in both the normal or inverted orientation. The normal orientation is such that the bottom edge of each tine is closest to the bottom of the tooth as shown in FIG. 6. The inverted orientation being that the top edge of each tine is closest to the bottom of the tooth.

First tine 8 outward edge 22 and second tine 9 outward edge 23 are shown in FIGS. 1, 4A and 4B. First tine 8 inner face 24 and second tine 9 inner face 25 are shown in FIGS.

4A and 4B. The inner surface of each of the tines can be made flat by techniques known in the art, e.g., extrusion, casting, blow molding, and machining The flat-sided inner face of each tine allows for better separation of two teeth, and can be used for both normal and wide preparations.

First tine 8 outer face 26 is shown in FIGS. 4A and 4B. In FIG. 4A, the outer edge 22 and 23 of tines 8 and 9, respectively are angled away from each other. In FIG. 4B, the outer edge 22 and 23 of tines 8 and 9, respectively are angled toward each other.

A further discussion of the configuration of the tines is found in U.S. Pat. No. 6,336,810, which is incorporated herein by reference.

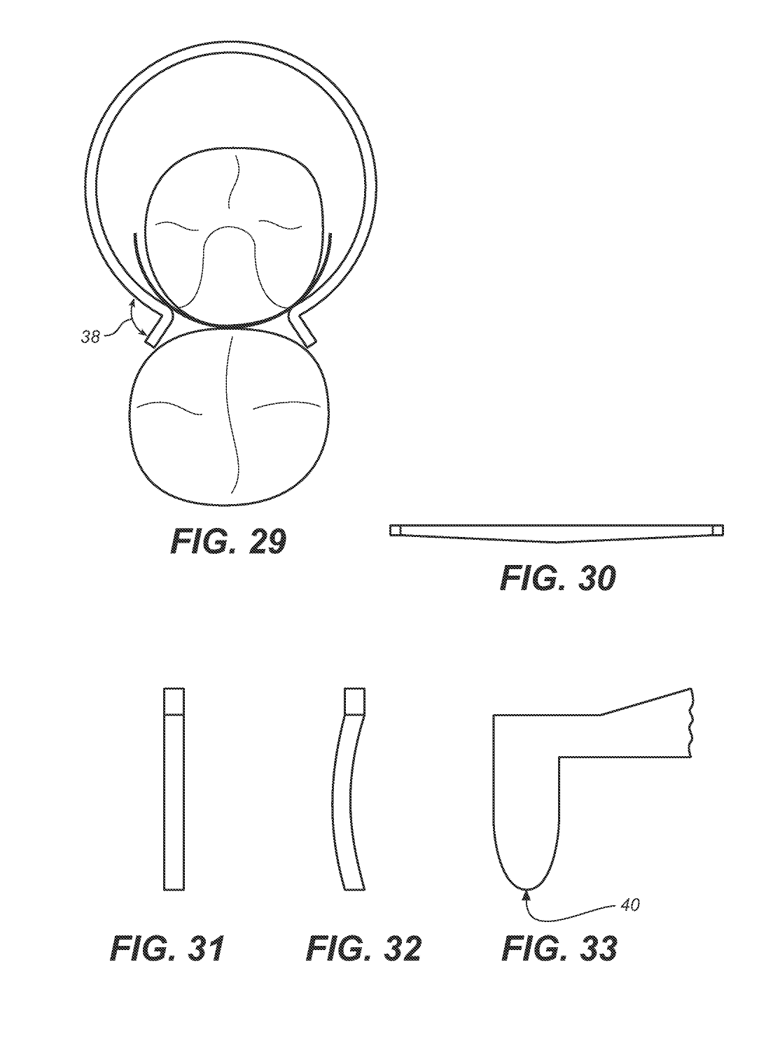

In another embodiment of the ring of this invention, at least one of the tines can have radiused or parabolic curved faces that form a ridge 37, as shown in FIG. 27, alone, and in FIGS. 28 and 29, as used on a select tooth. It is apparent from FIGS. 27-29 that this curve is across the faces of the tine from the outward edge to the inward edge. Tines having such a configuration are also referred to as folded tines. Each of the folded tines forms an angle 38 that conforms as far as possible to the interproximal area of a pair of teeth to allow the tine to grip on the round sites of the neighboring teeth adjacent to the select tooth on either side. The angle 38 is between about 65 and 130 degrees. The folds may also be multiple in number. Further, there may be an inverted V-shaped notch 39 along the ridge 37, as shown in FIG. 26 showing only a tine and the portion of the ring close to the tine. The notch allows a dental wedge to be inserted in between the teeth. The details of having an inverted V-shaped notch on one or both tines may be found in US Patent Application 2005/0147941, published Jul. 7, 2005, which is incorporated herein by reference.

In another embodiment of the ring of this invention, at least one of the tines can have a radiused or parabolic curved inner face along its length, as shown in FIG. 32. FIG. 31 shows a tine having straight inner and outer faces as a comparison. As shown in FIG. 32, this curve is along the length of the tine, i.e. from the top edge to the bottom edge, as opposed to the curve shown in FIGS. 27-29 for the folded tines. Tines having such a curved face are also referred to as longitudinally curved tines. In one embodiment, both the inner and outer faces of the tine are curved. In another embodiment, both tines have such curved inner and/or outer faces. The curved faces face generally in toward each other when the tines are in a converging orientation, which orientation shown in FIGS. 3A and 4B. The curved faces face generally away from each other when the tines are in a diverging orientation, which orientation is shown in FIGS. 4A and 3B. Such curved faces are intended to parallel the curve of the tooth surface to provide a more anatomical contact to the curved side of the tooth, resulting in a better seal with the shield. The curved faces can be achieved by various means including bending the tine or grinding the surface of the tine. Such tines can be incorporated on a ring with or without varying height.

In still another embodiment of the ring of this invention, at least one of the tines can have a curved bottom edge that comes to a point 40, as shown in FIG. 33. If used in conjunction with a contact wedge, the point 40 can enter a hole in the wedge and thus confine the wedge and the ring in place for the dental restoration process. Such tines can be incorporated on a ring with or without varying height.

All of the above-described tine configurations, such as the angles formed with the plane of the ring, the orientations of the two tines relative to each other, the curved face and the flat or curved bottom edge, can be used alone or in combination with one of more other configurations to provide maximum fit and restriction. Further, the two tines may have different configurations. Still further, in the case of removable tines, a dentist may be able to choose tines with different configurations to better fit the tooth of the particular patient being treated.

A second aspect of this invention is a method of preparing a tooth for restoration, which comprises (a) placing a shield between two or more teeth, one tooth being a select tooth for restoration; (b) inserting between the select tooth and a tooth adjacent to the select tooth, a flexible, open-ended dental ring with two tines of this invention as discussed previously; and (c) causing the tines of the ring to gently press the select tooth away from the adjacent tooth, and to secure the shield against the select tooth. The result is observed in FIGS. 6, 28 and 29.

This aspect of the invention is illustrated in part in FIG. 6. FIG. 6 shows the use of an open-ended ring 1 and a shield 32 in the preparation of a select tooth 29 for restoration. The shield 32 is placed between the select tooth 29 and an adjacent tooth 30. The shield is also referred to as a matrix and is a thin, flexible material that can be retained in place by the ring. The shield is not more than about a millimeter thick, generally less. The bottom surface 6 of the ring 1 is shown at an acute angle from the upper flat table 31 of the select tooth 29. Preferably, the bottom surface 6 of the ring 1 is at an angle ranging from about 10 to 25 degrees from the upper flat table 31 of the select tooth 29. An optional wedge 33 is illustrated in FIG. 7, in conjunction with a shield 32 being placed between a select tooth 29 and an adjacent tooth 30. Types of wedges that can be used are Cure Thru, a clear wedge, wooden, a custom wedge, or any other wedge known in the art. The shield can include, but is not limited to, an autoclavable material selected from the group consisting of alloy, chrome, stainless steel, rubber and plastic. Autoclaving allows for sterilization of shield. The shield may also be disposable. Alternatively, the shield can be sterilized by treatment with alcohol or other disinfectants. Shield shape can be elliptical, kidney-shaped, rod-like, oblong, square or rectangular. While the ring shown in FIG. 6 is singular, a plurality of shields 32 and rings 1 can be employed as illustrated in FIG. 8. FIG. 8 illustrates the usage of two open-ended rings 1 and two shields 32 in restoring a select tooth 29. The angle formed between the bottom surface 6 of the ring 1 and table 31 of the select tooth 29, allows for stacking of two or more rings, and clearance over obstacles like shields or wedges. A modification, as descried above, of FIG. 8, would be wherein one or more rings are in an inverted position relative to the other ring or rings.

A third aspect of this invention is a kit for preparing teeth for restoration, comprising (a) one or more flexible, open-ended dental rings of this invention; and (b) one or more shields designed for use with the open-ended dental rings; and (c) optionally one or more dental wedges.

The kit for preparing teeth for restoration, comprises one or more flexible, open-ended rings 1 and one or more shields 32. The open-ended ring 1 can be sold in a kit with one or more rings 1 and one or more shields 32. The open-ended ring 1 can also be sold separately or in a package of a select number. A kit may also include one or more tines that can be incorporated into the open ends of the ring. Such tines may be any of the described-above configurations or combinations thereof. A kit may also include one or more wedges.

The shield and wedge are known in the art and can be obtained from companies such as Danville Material, Garrison Dental Solutions, Inc., and other companies.

Instruments for inserting a ring, a wedge or a shield between two teeth, are known in the art and can be obtained from companies such as Danville material, Garrison Dental Solutions, Inc., and other companies. Instruments such as rubber dam clamp forceps, Howe Pliers, dressing forceps, hemostat, or cotton pliers can be used to insert the ring, wedge, or shield between two teeth.

A fourth aspect of this invention is a method for preparing the open-ended ring, comprising forming a flexible, open-ended dental ring of this invention in accordance with techniques known in the art.

The ring of the invention can be made by techniques known in the art, such as extrusion, casting, blow molding, injection molding, heat treating, and machining The ring is preferably an autoclavable material selected from the group consisting of alloy, chrome, stainless steel, rubber and plastic. While the materials useful for making the ring of this invention are known to one of skill in the art, those materials described in U.S. Pat. Nos. 5,681,528 and 5,855,844 are particularly useful, both of which are incorporated herein by reference. Precipitation hardenable stainless steel such as Carpenter Technology Corp's Custom 17-4, 17-7, 450, 455 or 465® stainless steel heat treated to RH 950 are found to be satisfactory for making the ring although other suitable materials may also be used.

### EXAMPLES

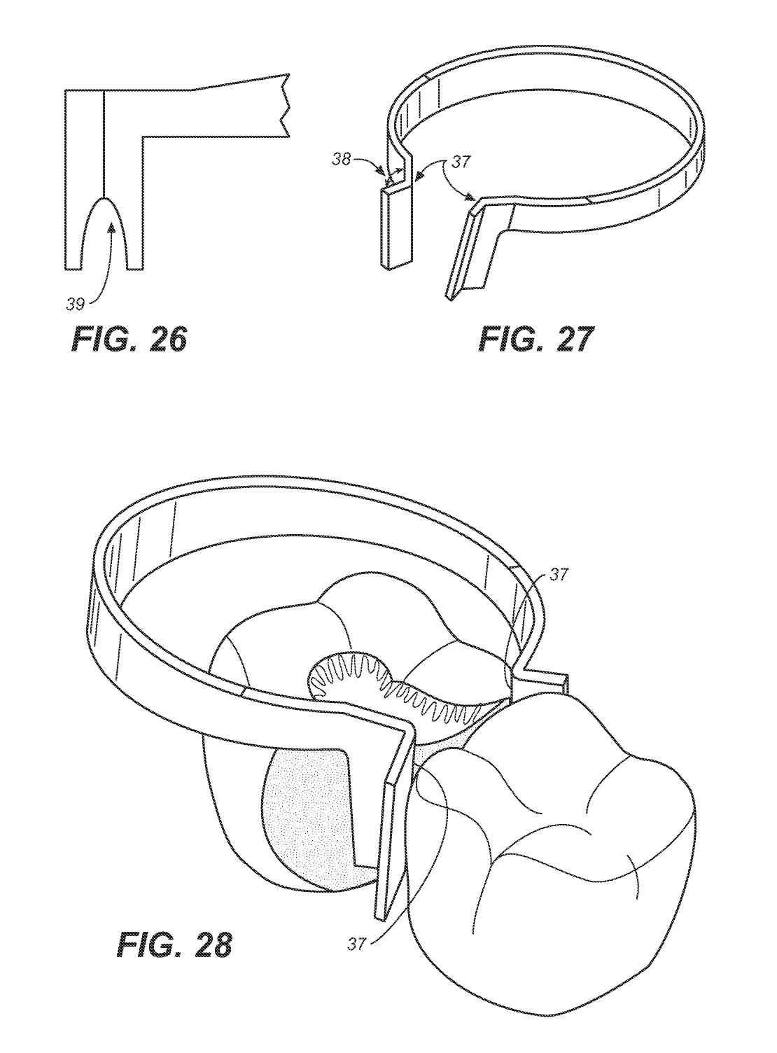

Two examples are included to exemplify numerous specific embodiments of the invention and are meant to be representative, but not to limit in any way the scope of the invention. FIGS. 10-17 are discussed in example 1, while FIGS. 18-25 are discussed in example 2. The differences will be apparent to one of skill in the art upon reading the examples, each of which describes an aspect of this invention.

### Example 1

This Example provides a brief description of FIG. 10-17, each of which presents specific aspects of a dental ring of this invention. FIG. 10 shows a bottom perspective view of a dental ring of this invention, while FIG. 11 is a top perspective view and FIG. 12 shows a frontal view. It will be noted that tip of each tine is angled toward the other, with each face angled away from the ring interior. One can observe from side views of FIGS. 14 and 15 that the tines are shown to be at an obtuse angel relative to the ring, e.g. about 102 degrees. Other suggested dimensions are as noted on the figures or as the following:

inside diameter of the ring is about 0.80 in;

minimum height of the ring is about 0.120 in;

maximum height of the ring is about 0.150 in;

thickness of the ring is about 0.042 in;

length of the tines is about 0.19 in; and

width of the tines is about 0.130 in; and

the gap between the tips of the two tines is about 0.035 in.

Suggested material for making the ring is for example, Carpenter Custom 465® stainless steel. The ring is finished by heat treatment to Specification RH950, then by passivating for about 30 minutes in a solution of about 20% by volume nitric acid containing about 3 oz /gal of sodium dichromate at about 120-140 ° F., followed by water rinse.

In one embodiment, sharp corners are deburred and broken. Preferably the surface is free of scale and foreign particles.

Other details not specified can be determined by those skilled in the art.

### Example 2

This example provides a brief description of FIGS. 18-25, each of which presents specific aspects of a dental ring of this invention. FIG. 18 shows a bottom perspective view of a dental ring of this invention, while FIG. 19 is a top perspective view and FIG. 20 shows a frontal view. The suggested dimensions for the gap between the tines, the angles of the tines, the relative placement of the tine faces, the size of the ring (including the variable height, thickness, tine length) and the other details are provided. It will be noted that tip of each tine is angled toward the other, with each face angled toward the ring interior. One can observe from side views of FIGS. 22 and 23 that the tines are shown to be at an obtuse angle relative to the ring, e.g. about 102 degrees.

Other suggested dimensions are as noted on the figures or as the following:

inside diameter of the ring is about 0.80 in;

minimum height of the ring is about 0.120 in;

maximum height of the ring is about 0.150 in;

thickness of the ring is about 0.042 in;

length of the tines is about 0.19 in;

width of the tines is about 0.130 in; and

the gap between the tips of the two tines is about 0.035 in.

Suggested material for making the ring is for example, Carpenter Custom 465® stainless steel. The ring is finished by heat treatment to Specification RH950, then by passivating for about 30 minutes in a solution of about 20% by volume nitric acid containing about 3 oz /gal of sodium dichromate at about 120-140° F., followed by water rinse.

In one embodiment, sharp corners are deburred and broken. Preferably the surface is free of scale and foreign particles.

Other details not specified can be determined by those skilled in the art.

Having completed the description of the ring, a kit, its method of use, and a method of making the ring, in both broad and narrow aspects, as well as preferred aspects, one of ordinary skill in the art may identify other aspects of the invention that would be apparent and obvious to one upon reading the specification. Such aspects of the invention are meant to be included within the scope of this disclosure and claims.

1. A flexible, open-ended dental ring having top and bottom surfaces that define a varying height of the ring, wherein the height of the ring is (a) at its maximum at about the middle of the closed portion of the ring, and (b) at its minimum near the open portion of the ring, with the maximum height of the ring being sufficient to prevent the ring from permanently deforming when the open ends are spread for placement on a tooth.

2. The ring of claim 1, wherein the thickness of the ring is uniform.

3. The ring of claim 2, wherein the maximum height is from about 110% to about 200% of the minimum height.

4. The ring of claim 3, wherein the maximum height of the ring is about 125% of the minimum height of the ring.

5. The ring of claim 4, wherein the thickness of the ring is from about 0.035 in to about 0.20 in, the height of the ring at its maximum is from about 0.12 in to about 0.18 in, the height of the ring at its minimum is from about 0.10 in to about 0.14 in.

6. The ring of any one of claims 1-5, wherein the inner diameter of the ring is from about 0.6 in to about 1.0 in, and the open ends can be spread up to about 12 millimeters without permanent deforming.

7. The ring of claim 6, wherein the inner diameter of the ring is about 0.8 in, and the open ends can be spread up to about 12 millimeters without permanent deforming.

8. The ring of claim 1, comprising an autoclavable metal.

9. The ring of claim 1, comprising an autoclavable plastic.

10. The ring of claim 1, wherein the thickness of the ring is not uniform.

11. The ring of claim 1, having two downwardly extending tines that are incorporated into the open ends of the ring about opposite from the opposing closed portion of the ring, wherein each tine has a top edge and a bottom edge.

12. The ring of claim 11, wherein the tines are incorporated into the open ends of the ring by a connection means whereby the tines can be attached to the open ends when needed and detached from the open ends when detachment is desired.

13. The ring of claim 11, wherein the tines are permanently incorporated into the open ends of the ring.

14. The ring of claim 11, wherein the ring and the tines are made from the same material.

15. The ring of claim 11, wherein the ring and the tines are made from different materials.

16. The ring of claim 11, wherein each tine has an outward edge and an inward edge, and the outward edge of a tine is parallel to the outward edge of the other tine.

17. The ring of claim 11, wherein each tine has an outward edge and an inward edge, and the outward edge of a tine diverges away from the outward edge of the other tine.

18. The ring of claim 11, wherein each tine has an outward edge and an inward edge, and the outward edge of a tine converges towards from the outward edge of the other tine.

19. The ring of claim 11, wherein the distance from the top edge to the bottom edge of each tine is from about 0.16 in to about 0.22 in.

20. The ring of claim 11, wherein the width of each of the tines as defined by the distance between the inward edge and the outward edge is from about 0.10 in to about 0.20 in.

21. The ring of claim 20, wherein the width of each of the tines is from about 0.10 in to about 0.15 in.

22. The ring of claim 11, wherein at least one of the tines is a radiused or parabolic curved tine that approximate a ridge shape.

23. The ring of claim 22, wherein the radius or parabolic curved tine has a notch in the shape of an inverted “V” along the ridge.

24. The ring of claim 11, wherein at least one of the tines has a curved bottom edge that comes to a point.

25. The ring of claim 11 or claim 24, wherein at least one of the tines has a longitudinally curved inner face.

26. A flexible, open-ended ring, having two downwardly extending tines incorporated into the open ends of the ring, wherein each tine has a top edge, a bottom edge, an outward edge, an inward edge, an inner face, and an outer face, and at least one tine has a curved bottom edge that comes to a point.

27. The ring of claim 26, wherein at least one of the tines has a longitudinally curved inner face.

28. A flexible, open-ended ring, having two downwardly extending tines incorporated into the open ends of the ring, wherein each tine has a top edge, a bottom edge, an outward edge, an inward edge, an inner face, and an outer face, and at least one tine has a longitudinally curved inner face.

29. A method for preparing a tooth for restoration, which method comprises:
(a) placing a shield between two or more teeth, one tooth being a select tooth for restoration;
(b) inserting between the select tooth and a tooth adjacent to the select tooth, a flexible open-ended dental ring of claim 11; and
(c) causing the tines of the ring to gently press the select tooth away from the adjacent tooth, and to secure the shield against the select tooth.

30. The method of claim 29, wherein the ring is as defined in claim 26 or claim 28.

31. A kit for preparing teeth for restoration, comprising:
(a) one or more flexible open-ended dental rings of any one of claims 1, 11, 26, and 28; and
(b) one or more shields designed for use with the open-ended rings.

32. The kit of claim 31, further comprising one or more tines.

33. (canceled)

34. A method for preparing a flexible, open-ended dental rings, which method comprises forming a ring of any one of claims 1, 11, 26, and 28.
